(19) United States
(12) Patent Application Publication
(10) Pub. No.: US 2026/0146721 A1
(43) Pub. Date: May 28, 2026

(54) Light Head Having IP Camera Integrated Seamlessly with a Light Source and Smart Streetlight Comprising the Same

(71) Applicant: Streetline Technology LLC, San Mateo, CA (US)

(72) Inventor: Anastasios Zografos, San Mateo, CA (US)

(21) Appl. No.: 18/957,528

(22) Filed: Nov. 22, 2024

(51) Int. Cl. H04N 7/18; F21S 8/08; F21V 33/00; F21W 131/103

(52) U.S. Cl. CPC F21S 8/086; F21V 33/00; F21W 2131/103

(57) ABSTRACT

A light head includes a housing, a light source integrated with a main body of the housing, an internet protocol (IP) camera having a base fastened to an access panel of the housing, a network communication module disposed within the housing, and a power distribution system including a terminal block disposed in the housing. The network communication module is electrically connected to the IP camera and the terminal block of the power distribution system and is operative to wirelessly transmit data produced from images captured by the IP camera. The light source and the IP camera are electrically connected to the terminal block independently of each other, and the power distribution system is configured to supply at least some power for powering the light source and the IP camera from the main power supply line through the terminal block.

### BACKGROUND

The present technology relates to streetlights and to the light heads of streetlights. The present technology also relates to outdoor cameras and to monitoring, management and surveillance systems including the same.

Streetlights are provided alongside roads, intersections, paths, mass transit platforms, etc., to illuminate certain areas beneath them. The basic components of a streetlight include a light head having a light source and a housing that houses the light source, a light pole to which the light head is fixed at a height above ground level and wiring for connecting the light source to a main utility power supply line. The light pole is typically made of steel or concrete and supports the light head at a height of about 10-40 feet above ground level. The light source of the light head has traditionally been a high-pressure sodium or metal halide lamp, but LEDs are often now being used instead due to their energy efficiency and longer lifespan. In the case of traditional light sources, the light head also includes ballast to regulate the supply of power to the light source, while in the case of LEDs, LED drivers which convert relatively high voltage AC to lower voltage DC connect the main utility power supply line to the LEDs.

Outdoor cameras are used nowadays for various reasons, such as a safety measure to deter or record crime or for traffic or parking control. In the case of outdoor traffic or parking control, outdoor cameras track vehicles by license plate number, for example, so that images of license plates captured by outdoor cameras can be used to alert police to speeders or the presence of vehicles registered to persons having an outstanding warrant. Outdoor cameras can also be used to monitor traffic or parking lots for more efficient management of traffic or parking, or to collect information useful for developing public policy around vehicle use. In many of these cases, the image data captured by the outdoor camera must be transmitted wirelessly over a network for at least the practical reason that the camera is not readily accessible by cable. Cameras which produce image data formatted for wireless transmission are classified as internet protocol (IP) cameras.

Therefore, in certain outdoor spaces it might be desirable to provide outdoor cameras, and especially IP cameras, on streetlights. However, outdoor cameras have operating requirements, e.g., required times of operation, which may differ widely from those of streetlights. Similarly, outdoor cameras may have power requirements which differ from those of streetlights. Still further, municipalities may have restrictions as to the appearance of their streetlights, which would prohibit simply mounting an outdoor camera to a streetlight and wiring it to the main utility power line.

### SUMMARY

One object of the present technology is to provide a light head having a light source and an outdoor camera integrated seamlessly with the light source, as well as to provide a streetlight comprising the same.

Another object of the present technology is to provide an assembly by which an existing light head of a streetlight can be readily retrofitted to include an outdoor camera. A more specific object of the present technology is to provide the ability to transform streetlights into powerful multi-functional assets.

Yet another object of the present technology is to provide a light head of a streetlight which will readily meet common municipal requirements.

Still another object of the present technology is to provide a streetlight with advanced technology within a single infrastructure element, which can offer a transformative approach to urban management, e.g., by enhancing any or each of curbside management, parking management, security, and overall city infrastructure efficiency, thereby driving smarter cities and creating more sustainable urban ecosystems.

According to one aspect of the present technology, there is provided a light head comprising a housing including a main body having an opening, and an access panel disposed over the opening and mounted to the main body so as to be openable to expose an interior of the housing, a light source integrated with the main body of the housing and operable to shine a beam of light in a direction away from the housing, an internet protocol (IP) camera having a base fastened to the access panel and at least one lens supported by the base as exposed to the exterior of the housing, and a power distribution system disposed within the housing and wired for electrical connection to a main power supply line. The light source and the IP camera are electrically connected independently of one another in the power distribution system, and the power distribution system is configured to distribute at least some power for powering the light source and the IP camera from the main power supply line.

According to another aspect of the present technology, there is provided a light head comprising a housing, a light source integral with the housing and positioned to shine a beam of light in a direction away from the housing, an internet protocol (IP) camera including a base mounted to the housing, and at least one lens supported by the base as exposed to the exterior of the housing, and a power distribution system including a terminal block disposed in the housing and dedicated for being wired to a main power supply line, the light source and the IP camera being electrically connected to the terminal block independently of each other. The power distribution system is configured to supply at least some power for powering the light source and the IP camera from the main power supply line through the terminal block.

According to yet another aspect of the present technology, there is provided a light head comprising a housing including a main body having an opening and an access panel disposed over the opening and mounted to the main body so as to be openable to expose an interior of the housing a lighting system, a light source integrated with the main body of the housing and operable to shine a beam of light in a direction away from the housing, an internet protocol (IP) camera having a base fastened to the access panel and at least one lens supported by the base as exposed to the exterior of the housing, a network communication module disposed within the housing, and a power distribution system including a terminal block disposed in the housing. The network communication module is electrically connected to the IP camera and the terminal block of the power distribution system and is operative to wirelessly transmit data produced from images captured by the IP camera. The light source and the IP camera are electrically connected to the terminal block independently of each other, and the power distribution system is configured to supply at least some power for powering the light source and the IP camera from the main power supply line through the terminal block.

According to still other aspects of the present technology, streetlights having the light heads described above are provided.

Still further, the streetlights may be smart streetlights or part of smart streetlight systems provided with video analytics, machine learning and/or artificial intelligence (AI).

### BRIEF DESCRIPTION OF THE DRAWINGS

These and other objects, features and advantages of the present technology will be better understood from the detailed description of preferred embodiments and examples thereof that follow with reference to the accompanying drawings, in which:

FIG. 1 illustrates a streetlight according to the present technology, and includes block diagrams of power distribution and network/communication systems of the streetlight at the right-hand side of the figure;

FIG. 2 is a perspective view of an example of a light head of a streetlight of FIG. 1, according to the present technology;

FIG. 3 is a block diagram of an example of an IP camera of a light head according to the present technology;

FIG. 4A-C are schematic diagrams of examples of a light head of a streetlight according to the present technology;

FIGS. 5A-5D are conceptual diagrams illustrating one example of operations in the manufacture of a light head or retrofitting of an existing light head according the present technology, wherein FIG. 5A includes bottom and side views of a built-out access panel of the light head, FIG. 5B is a bottom view of the access panel at an initial stage of the build-out, FIG. 5C is a top view of the access panel with camera installed, and FIG. 5D is a bottom view of the access panel with camera installed;

FIGS. 6A-6D are conceptual diagrams illustrating another example of operations in the manufacture of a light head or retrofitting of an existing light head according to another example of the present technology, wherein FIG. 6A includes bottom and side views of a built-out access panel of the light head, FIG. 6B is a bottom view of the access panel at an initial stage of the build-out, FIG. 6C is a top view of the access panel with camera installed, and FIG. 6D is a bottom view of the access panel with camera installed; and

FIG. 7 is a block diagram of an example of a machine of a smart streetlight or smart streetlight system according to the present technology.

### DETAILED DESCRIPTION

Embodiments of the present technology and examples thereof will now be described more fully in detail hereinafter with reference to the accompanying drawings. In the drawings, elements may be shown schematically for ease of understanding. Also, like numerals and reference characters are used to designate like elements throughout the drawings. Certain examples of elements of the present technology may be described and illustrated in terms of blocks which carry out a described function or functions. These blocks, which may be referred to herein as modules or the like, are physically implemented by analog and/or digital circuits such as logic gates, integrated circuits, microprocessors, microcontrollers, memory circuits, passive electronic components, active electronic components, optical components, hardwired circuits and the like, and may be driven by firmware and/or software of non-transitory computer readable media (CRM). In the present disclosure, the term non-transitory computer readable medium (CRM) refers to any medium that stores data in a machine-readable format for short periods or in the presence of power, such as a memory device or Random Access Memory (RAM). The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the examples may be physically separated into two or more interacting and discrete blocks and conversely, the blocks of the examples may be physically combined into more complex blocks while still providing the essential functions of the present technology.

The terminology used herein for the purpose of describing embodiments of the present technology is to be taken in context. For example, the term “comprises” or “comprising” when used in this disclosure indicates the presence of stated features but does not preclude the presence of additional features. The term streetlight will be understood as referring to basically any outdoor lighting structure having a raised light source, regardless of the area to be lit by the light source (street, path, parking lot, etc.). The term “light pole” will be understood as referring to any structure which will stand substantially upright when employed and support a light head at a level above the ground. The term IP camera will be understood as referring to any camera that captures images and produces corresponding image data in a format which allows the data to be transmitted wirelessly either directly or by simple processing.

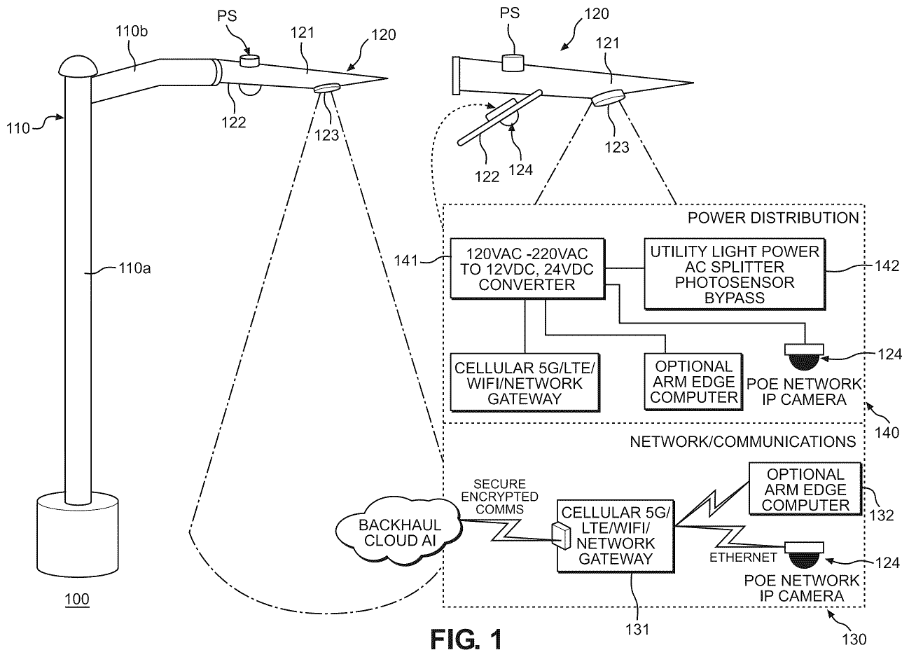

Referring to FIG. 1, a streetlight 100 according to the present technology has a light pole 110 and a light head 120 fixed to the light pole 110 as raised above the level of the area which is to be illuminated by the streetlight 100. In this example, the light pole 110 has a vertical section 110a and an arm 110b extending generally horizontally from an upper portion of the vertical section 110a. The light head 120, shown as broken away from the light pole 110 at the righthand side of the figure, may be detachable from the arm 110b for replacement or maintenance. The streetlight 100 may also include a photosensor PS, known per se. The photosensor PS includes a photocell, and a control circuit and a relay inside the housing of the light head 120. The photocell is wired to the control circuit which in turn activates the relay to switch the power on and off based on ambient light levels. Alternatively, the streetlight 100 is operated by a timer. Other types of switches may also take the place of the photosensor PS or timer. Also, in an example of a smart streetlight according to the present technology, the light source may be remotely controlled to turn on/off or even dim depending on traffic patterns or time of day.

As shown best at the right-hand side of FIG. 1, the housing of the light head 120 includes a main body 121 having an opening therein, and an access panel 122 disposed over the opening and mounted to the main body 121 so as to be openable to expose an interior of the housing, a light source 123 integrated with the main body 121 of the housing and operable to shine a beam of light in a direction away from the housing, and an internet protocol (IP) camera 124 mounted to the access panel 122. The light source 123 may include one or more LEDs, such as an LED panel comprising an array of LEDs disposed at the exterior of the main body 121 of the housing as integral therewith. The IP camera 124 has a base fastened to the access panel 122, and at least one lens supported by the base as exposed to the exterior of the housing. The photosensor PS is operative to control the light source 123 to turn on and off depending on the amount of ambient light sensed by the photocell. In a streetlight application of the present technology, the photosensor PS turns the light source 123 on at dusk and off at dawn.

The light head 120 may also include a network/communication system 130 and a power distribution system 140 disposed within the housing as accessible when the access panel 122 is open (as indicated by the dotted line arrow). Components of the network/communication system130 and power distribution system 140 may be provided on an inner side of access panel 122, as will be described later in more detail.

The network/communication system 130 has a network communication module 131 electrically connected to the IP camera 124 by the power distribution system 140.

The network communication module 131 is operative to wirelessly transmit data produced from images captured by the IP camera 124, to the cloud, for example. In examples of the present technology, the network communication module 131 is an encrypted communication gateway module (CGM) supporting a cellular 4G LTE or 5G Wi-Fi network protocol. Optionally, the network/communication system 130 includes an edge computer 132 for processing image data output by the IP camera 124 at a location close to the IP camera 124, and the output of which is transmitted by the network communication module 131 to the cloud. In either case, as also shown in FIG. 1, the streetlight 100 may be part of a smart streetlight system using backhaul cloud computing, i.e., the network communication module 131 provides a high capacity, low latency line in which data from the IP camera 124 or edge computer 132 is transmitted efficiently and rapidly to a remote network or data center for storage, processing, etc.

The power distribution system 140 is electrically connected to the light source 123, the IP camera 124 and the network/communication system 130. As will be described in more detail below with respect to certain examples of the present technology, the power distribution system 140 is configured for electrical connection to a main power supply line, e.g., a utility light power line. Accordingly, the power distribution system 140 distributes at least some power for powering the light source 123, the IP camera 124 and component(s) of the network/communication system 130 from the main power supply line. In this example, the power distribution system 140 includes an AC/DC power supply (rectifier) 141 for converting the AC power supplied by the utility power line to DC power required by electronic components of the light head 120. FIG. 1 also shows a photocell bypass circuit 142 by which the power distribution system 140 can supply power to the IP camera 124 and network/communication system 130 while bypassing the control by the photocell sensor PCS, so that the IP camera 124 and network/communication system 130 can be powered during the daytime even when the light source 123 is not.

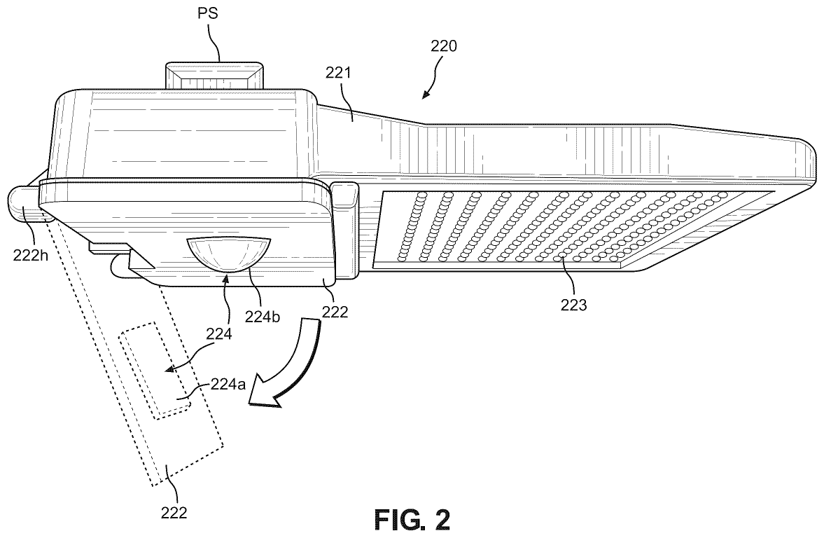

FIG. 2 shows another example of a light head according to the present technology, similar to that shown in FIG. 1. The light head 220 has a housing including a main body 221 having an opening therein, and an access panel 222 disposed over the opening and mounted to the main body 221 by hinges 222H so as to be openable (as shown by the arrow) to expose an interior of the housing, a light source 223 integrated with the main body 221 of the housing and operable to shine a beam of light in a direction away from the housing, and an internet protocol (IP) camera 224 mounted to the access panel 222. The light source 223 of this example is an LED panel comprising an array of LEDs. The IP camera 224 has a base 224a fastened to the access panel 122, and at least one lens 224b supported by the base 224a as exposed to the exterior of the housing. A photosensor PS is operative to control the light source 223 to turn on and off depending upon the amount of ambient light sensed by the photosensor PS.

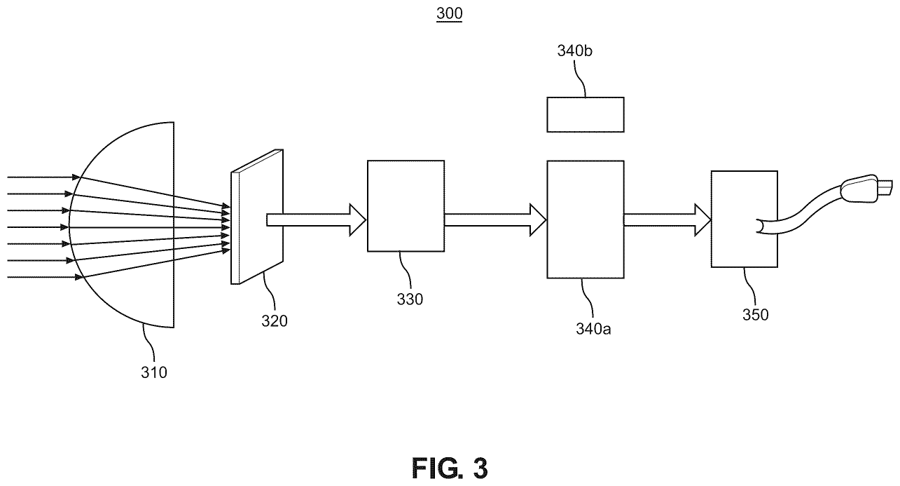

FIG. 3 shows basic components of an example of an IP video camera 300, according to the present technology. Like the IP camera 124 or 224, the IP video camera 300 includes at least one lens 310, an image sensor 320 which produces video image data, and an image processing unit 330 which processes image data by the image sensor 320 and compresses it using a video CODEC. The at least one lens 310 focuses light onto the image sensor 320 and determines the field of view and image quality of the camera 300. The smart camera also includes a CPU and/or GPU 340a and memory 340b for extracting information from the processed and compressed image data output by the image processing unit 330, and an ethernet interface 350 by which the video recorded on the memory 340b and/or data of the information extracted by and output by the CPU 340b can be uploaded to the cloud via a network/communication system such as system 130 shown in and described with reference to FIG. 1. All these components may be provided in a module comprising a printed PCB, chip package or the like housed within the base of the IP video camera 300, which base is fastened to the access panel as shown in FIG. 2 with respect to base 224a of IP camera 224.

The IP video camera 300 may be a smart camera. When provided with a CPU and/or GPU, for example, the smart camera can include video analytics and/or a neural network capable of image recognition in applications described later on. According to one example of such a smart camera, compressed and processed video data is stored on the memory 340b, and CPU 340a extracts information from the video data such as the license plate number in the image of a vehicle captured by the IP video camera 300. A smart camera employed by a light head according to the present technology may also have a motion sensor to detect motion and trigger an action like the initiation of the recording of video. Specific examples of smart cameras which may be employed by a light head, such as light head 120 or 220, according to the present technology include but are not limited to automatic number plate recognition (ANPR) cameras, speed cameras, dome cameras, PTZ cameras and multiple lens or fisheye cameras. APNR cameras use AI to identify license plate numbers and track vehicles. Speed cameras can be used alongside roads to monitor traffic. PTZ cameras can pan, tilt, and zoom to track and follow objects like vehicles. Multiple lens or fisheye cameras capture panoramic images with a single camera, which can be useful for monitoring parking lots.

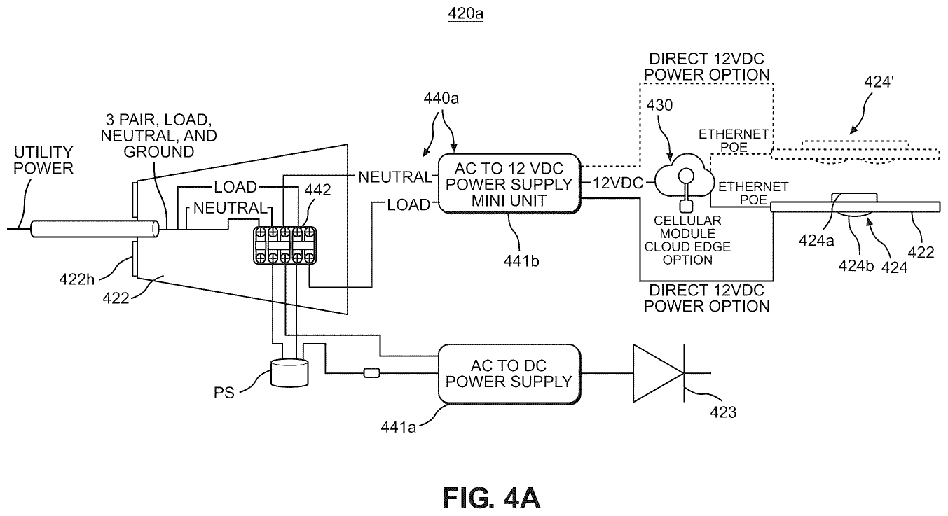

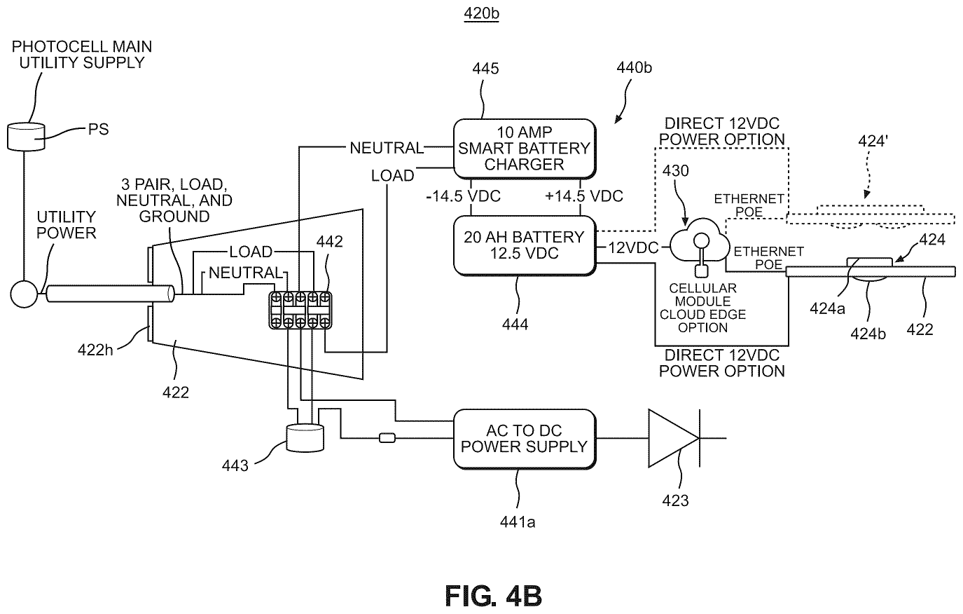

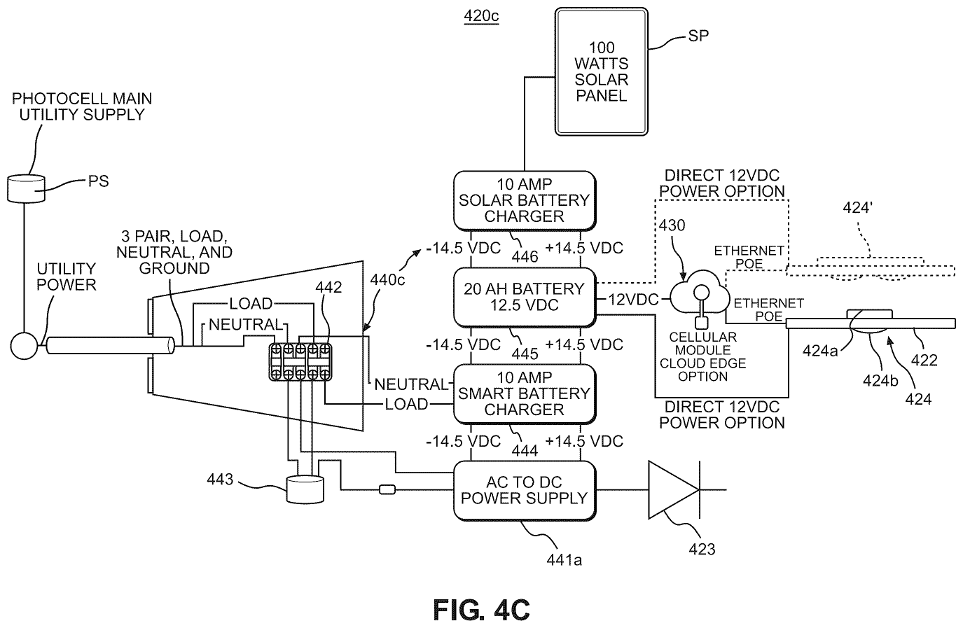

An example of an integrated light source/IP camera of a light head 420A, with day/night photocell bypass, according to the present technology will now be described with reference to FIG. 4A. Only certain elements of the light head 420A are shown for clarity, with the other elements, such as the main body of its housing, being similar to those shown in and described with reference to FIGS. 1 and 2 but omitted in FIG. 4A for clarity. The light head 420A comprises a housing (not shown) having an access panel 422 mounted to a main body of the housing by hinges 422H so as to be openable to expose an interior of the housing, at least one LED as a light source 423, and an internet protocol (IP) camera 424 mounted to the access panel 422. The IP camera 424 has a base 424a fastened to the access panel 422, and a single lens 424b supported by the base 424a as exposed to the exterior of the housing. A photocell PC is operative to control the light source 423 to turn on and off depending upon the amount of ambient light sensed by the photocell PC. Reference character 424′designates a dual lens camera as another example of the IP camera of the light head 420A.

The light head 420A also includes a network/communication system 430 and a power distribution system 440a disposed within the housing (not shown) of the light head 420A as accessible when the access panel 422 is open. The network/communication system 430 has a cellular communication module operative to wirelessly transmit data produced from images captured by the IP camera 424 to the cloud. In the illustrated example, the network/communication system 430 also includes an edge computer for processing image data output by the IP camera 124 at a location close to the IP camera 124 and the output of which is transmitted to the cloud. The network/communication system 430 is electrically connected to the IP camera 424 by a Power over Ethernet (POE) cable of the power distribution system 440a, as shown in the figure.

The power distribution system 440a also includes an AC/DC power supply unit 441a electrically connected to the light source 423, a mini AC/DC power supply unit 441b electrically connected to the network communication system 430 and IP camera 424a terminal block 442, and a terminal block 442 to which the light source 423, the IP camera 424 and the network/communication system 430 are wired via the AC/DC power supply units 441a, 441b. The terminal block 442 is also wired to a utility power line. Accordingly, the AC/DC power supply units 441a, 441b convert the AC power supplied by the utility power line to DC power required by the light source 423, the IP camera 124 and the components of the network/communication system 430 (network communication module and edge computer).

Referring still to FIG. 4A, a photocell sensor PS is operative to control the light source 423 to turn on and off depending on the amount of ambient light sensed by the photocell sensor PS. Accordingly, the IP camera 424 and network/communication system 430 can be powered from the utility power line during the daytime even when the light source 423 is not.

FIG. 4B shows another example of an integrated light source/IP camera of a light head 420B, with day/night photocell bypass, according to the present technology. In this example, the power distribution system 440b has a photocell shorting cap 443, of the known type used for trouble shooting, and constituting a bypass circuit by which the power distribution system 440b can supply power to the IP camera 424 and network/communication system 430 while bypassing the photocell sensor PS. In addition, the power distribution system 440b includes a battery 444 and a smart battery charger 445 connecting the terminal block 442 to the network/communication module 431 and IP camera 424. The the smart battery charger 445 charges the smart battery 444 with power distributed thereto from the terminal block 442 when power is flowing from the utility power line to the terminal block 442, and the battery 444 powers the network/communication module 431 and IP camera 424 when no power is supplied to the terminal block 442 via the utility power line. In this light head 420B, the network/communication module 431 and IP camera 424 are powered during the day by the battery 444 charged during the night using the power supplied by the utility power line.

FIG. 4C shows another example of an integrated light source/IP camera of a light head 420C, with day/night central photocell, according to the present technology. In this example, the power distribution system also includes a solar energy battery charger 446 connected to the battery 444 to charge the battery 444 with solar power. The solar power can be supplied by a solar panel SP mounted to the streetlight, such as on its pole (110 in FIG. 1) or on the housing of the light head 420C. Accordingly, the network/communication module 431 and the IP camera 424 are powered during the day by the battery 444 charged during the night using the power supplied by the utility power line. On the other hand, the battery 444 will be supplied with solar power to provide power to the network/communication module 431 and the IP camera 424 system during all hours of the day and night even when there is no power available from the power supply line. Incorporating solar power offers significant benefits in terms of sustainability and cost savings. Solar panels can power both the streetlight and its integrated systems, reducing dependency on the grid and promoting energy efficiency. This renewable energy source ensures that the system remains operational during power outages, increasing resilience and providing continuous monitoring even in remote or underserved areas.

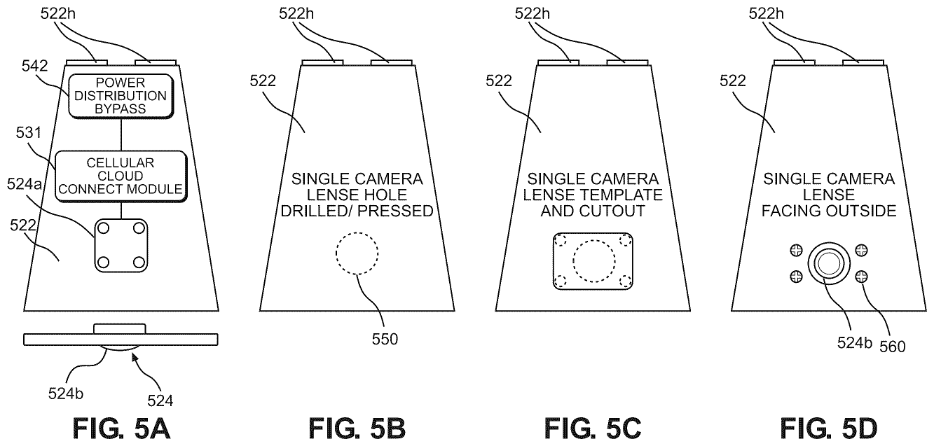

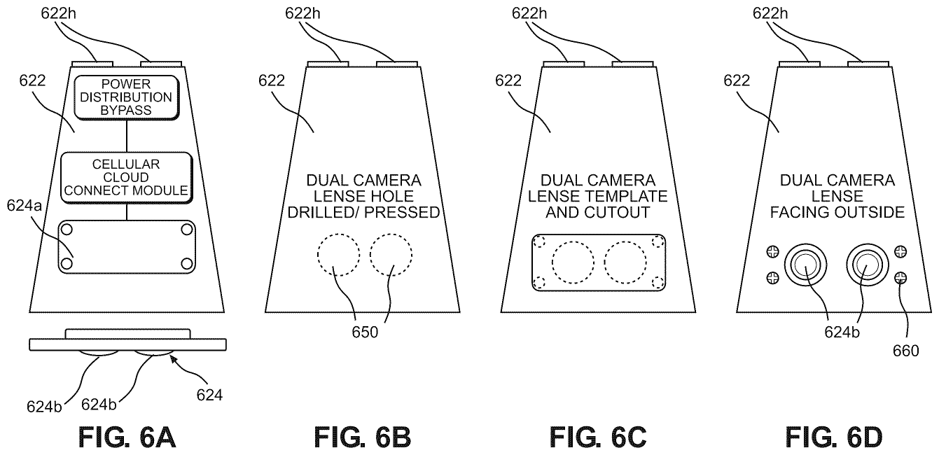

As shown in FIGS. 5A-5D and 6A-6D, the present technology is readily adapted for use in retrofitting existing light heads of streetlights with a camera system according to the present technology. In these examples, the camera system is mounted to a fabricated or existing access panel 522, 622 of a housing of the light head, and includes an IP camera (such as a smart network camera), power distribution and network/communication components of any of the types described above. In FIGS. 5A and 6A, three parts of the camera system are shown: a camera having a relatively flat box-like camera base 524a, 624a (containing image processor, CPU and/or GPU, memory, ethernet interface, etc. as shown in described with reference to FIG. 3) having four (4) holes therethrough for receiving screws, a cellular cloud module 531, 631 for placing the camera in communication with backend services and cloud Service as a Service (SaS) systems, and a power distribution bypass 542, 642 for powering the camera and cellular cloud module while bypassing control of the light source of the streetlight. Also, in these examples, the access panels 522, 622 are provided with hinges 522H, 622H but other means for mounting the access panels 522, 622 to a housing of a light head. Connections are made based on the application and power distribution at the site of the streetlight having the light head whose housing is provided with the access panel 522, 622.

FIGS. 5B-5D show steps in the manufacturing of the assembly shown in FIG. 5A. First, as shown in FIG. 5B, access panel 522 is marked with a circle corresponding to the outer contour of the camera lens 524b, and a circular hole 550 is drilled through the access panel 522 with a hole saw using the circle as a guide. As shown in FIG. 5C, a template (indicated by dashed lines in the figure) is provided on one side of the access panel 522. The template has a circle/circular opening aligned with the hole 550, and circles/circular openings corresponding to the four (4) holes in the base 524a of the camera 524 and used as a guide for drilling four (4) screw holes into the access panel 522. In this step, threads can be formed in the access panel 522, for example, with a tapping bit or the screw holes may allow for self-tapping by machine screws. FIG. 5D shows a step of mounting the camera 524 to the access panel by inserting the single lens 524b of the camera through the hole 550 from an inner surface of the access panel 522 so as to project outwardly from the access panel 522 and fastening the base 524a of the camera 524 to the inner surface of the access panel 522 by inserting the screws 560 into the corresponding holes in the base and screw holes in the access panel 622. Thus, in this example, the entirety of the base 524a of the camera 524 will be disposed in the housing of the light head when the access panel 522 is closed. In another example of this process, the template can have markings or openings for both the lens-receiving hole 550 and the screw holes.

FIGS. 6B-6D show steps in the manufacturing of the assembly shown in FIG. 6A. First, as shown in FIG. 6B, access panel 622 is marked with two circles corresponding to the outer contour of the camera lenses 624b of dual lens camera 624, and two circular holes 650 are drilled through the access panel 622 with a hole saw using the circles as guides. As shown in FIG. 6C, a template (indicated by dashed lines in the figure) is provided on one side of the access panel 622. The template has circles/circular openings aligned with the holes 650, and circles/circular openings corresponding to the four (4) holes in the base 624a of the camera 624 and used as a guide for drilling four (4) screw holes into the access panel 622. In this step, threads can be formed in the access panel 622, for example, with a tapping bit or the screw holes may allow for self-tapping by machine screws. FIG. 6D shows a step of mounting the camera 624 to the access panel 622 by inserting the lenses 624b of the camera through the holes 650 from an inner surface of the access panel 622 so as to project outwardly from the access panel 622 and fastening the base 624a of the camera 624 to the inner surface of the access panel 622 by inserting the screws 660 into the corresponding holes in the base and screw holes in the access panel 622. Thus, in this example, the entirety of the base 624a of the camera 624 will be disposed in the housing of the light head when the access panel 622 is closed. In another example of this process, the template can have markings or openings for both the lens-receiving holes 650 and the screw holes.

Streetlights according to the present technology, equipped with cameras, video analytics, machine learning and/or artificial intelligence (AI), referred to hereinafter as “smart streetlights”, can offer a transformative approach to urban management. These smart streetlights can enhance curbside management, smart parking, security, and overall city infrastructure efficiency.

### Curbside Management

Efficient curbside management is a growing challenge in urban areas due to the increasing volume of ride-hailing, e-commerce deliveries, and urban mobility options. Examples of smart streetlights according to the present technology can monitor curb usage in real time. The video data captured by the smart streetlights can be processed to detect vehicles stopping at curbs, differentiate between passenger drop-offs and delivery stops, and determine the duration of parking. This data helps municipalities enforce time limits, optimize curb space allocation, and even dynamically adjust curbside pricing based on real-time demand.

### Smart Parking Detection, Guidance, and Enforcement

Finding available parking is highly desirous for drivers in busy areas. Examples of smart streetlights according to the present technology can continuously monitor parking spots and detect when they are occupied or vacant. This information is relayed to drivers via apps or signage, guiding them to the nearest available parking space. For parking enforcement, these smart streetlights can automatically identify vehicles parked illegally or overstaying their time limits, sending alerts to enforcement officers or generating automated fines. The combination of detection, guidance, and enforcement improves parking efficiency and reduces congestion.

### Street and Sidewalk Domain Awareness and Security

Ensuring safety and security on streets and sidewalks is a top priority for urban planners. Examples of smart streetlights according to the present technology can continuously monitor public spaces, leveraging video analytics, machine learning and/or AI to identify suspicious activities, such as loitering, fights, or abandoned objects. These systems can be programmed to alert security personnel in real time when predefined behaviors are detected. In addition, streetlights with AI-driven analytics can monitor foot traffic, bicycle lanes, and vehicle interactions, providing insights to city planners for better urban design and resource allocation.

### Public and Private Infrastructure Management

Examples of smart streetlights according to the present technology can also serve as sentinels for infrastructure management. Video analytics and machine learning algorithms can detect issues like potholes, damaged street furniture, or obstructed sidewalks. By integrating this capability with municipal maintenance systems, problems can be automatically reported and prioritized for repairs, improving response times and reducing costs. Additionally, smart streetlights can monitor the condition of nearby buildings, bridges, and other infrastructure, identifying signs of wear or damage early and allowing for preventive maintenance.

### Environmental Monitoring and Data Collection

Examples of smart streetlights according to the present technology are also provided with sensors to monitor environmental factors like air quality, noise levels, and weather conditions. When combined with video data, AI can be leveraged to correlate environmental changes with patterns in human activity, offering a richer understanding of urban dynamics.

### Smart City Integration and Decision-making

Examples of smart streetlights according to the present technology function as a node within a broader smart city network. The data they collect can be aggregated with other sources to offer city administrators a comprehensive, real-time view of urban operations. AI-driven insights derived from this data can be used to help optimize resource allocation, improve public safety, and enhance citizen services. The system's adaptability, powered by machine learning, means it continuously improves as it processes more data, making the city's management more efficient over time.

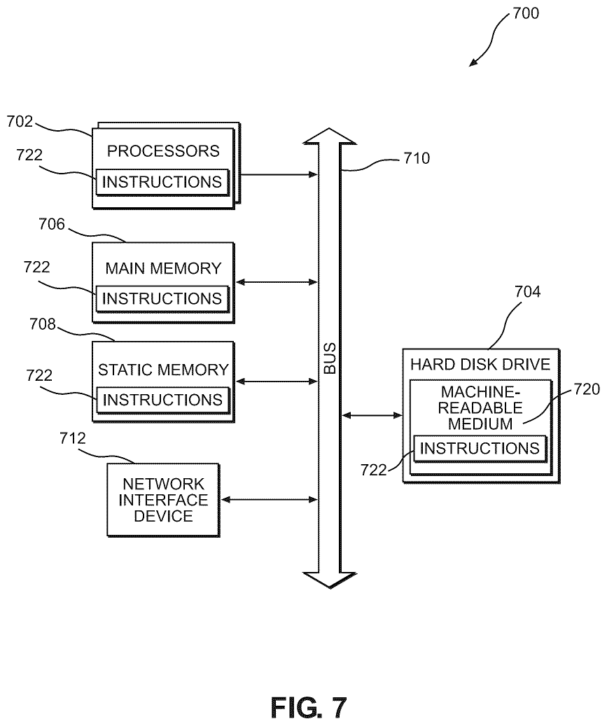

FIG. 7 is a diagrammatic representation of a machine 700 of the smart streetlight, within which a set of instructions are provided for causing the machine to execute processes in connection with the operations and enhancements described above. While only a single machine is illustrated, the term “machine” shall also be taken to include any collection of devices that individually or jointly execute a set (or multiple sets) of instructions to perform any one or more of the functions/processes discussed herein. Thus, machine 700 may constitute the IP camera 124 and optional edge computer 132 shown in and described with reference to FIG. 1, i.e., a smart camera of a light head according to the present technology.

Machine 700 includes a processor or multiple processors 702 (CPU and/or GPU for image processing and data extraction), a hard disk drive 704, a main memory 706, and a static memory 708, which communicate with each other via a bus 710. The machine 700 may also include a network interface device 712, e.g., the network communication module 131. The hard disk drive 704 may include a non-transitory computer-readable medium 720, which stores one or more sets of instructions 722 for carrying out or executing any of the functions/processes described herein. The instructions 722 can also reside, completely or at least partially, within the main memory 706, the static memory 708, and/or within the processors 702 during execution thereof by the machine 700.

As is clear from the description above, the present technology offers powerful multi-functional light heads having seamlessly integrated cameras and light sources.

As evident from the descriptions above, the present technology offers many benefits in terms of efficiency, safety, sustainability, and scalability. Specifically, streetlights provided with the same along with video analytics, machine learning and/or AI technology provide more than just lighting solutions; they are multi-functional tools that can be used especially in urban settings for enhancing/improving curbside and parking management, safety, and infrastructure upkeep. By enabling cities to harness real-time data and intelligent analytics, these streetlights drive smarter decision-making and create more sustainable urban ecosystems and thus have the potential to elevate the quality of life for urban residents and visitors alike. In terms of efficiency, the present technology allows urban management strategies to be continuously optimized based on real-time data and predictive analytics. The present technology may provide cost savings by, for example, reducing the need for manual enforcement and inspections, and predicting maintenance to prevent costly infrastructure failures. The present technology may provide real-time alerts and intelligent monitoring to enhance public safety including by lowering law enforcement response times. When provided with solar power capabilities, the present technology aligns with green initiatives and reduces overall energy consumption. And streetlights according to the present technology are easily scalable across different settings, from dense city centers to suburban and even rural areas.

Finally, although the present technology has been described above in detail with respect to various embodiments and examples thereof, the technology may be embodied in many different forms to implement the present invention. Thus, the present invention should not be construed as being limited to the embodiments and their examples described above. Rather, these embodiments and examples, as well as objects and advantages thereof, were described so that this disclosure is thorough, complete, and fully conveys the present invention to those skilled in the art. Thus, the true spirit and scope of the present invention is not limited by the description above but by the following claims.

What is claimed is:

1. A light head, comprising:
a housing including a main body having an opening, and an access panel disposed over the opening and mounted to the main body so as to be openable to expose an interior of the housing;
a light source integrated with the main body of the housing and operable to shine a beam of light in a direction away from the housing;
an internet protocol (IP) camera having a base fastened to the access panel, and at least one lens supported by the base as exposed to the exterior of the housing; and
a power distribution system disposed within the housing and wired for electrical connection to a main power supply line, and the power distribution system being configured to distribute at least some power for powering the light source and the IP camera independently of one another from the main power supply line.

2. The light head as claimed in claim 1, wherein the base of the IP camera extends within the housing, the access panel has at least one hole therethrough, and the IP camera protrudes from the housing through the at least one hole in the access panel.

3. The light head as claimed in claim 1, wherein the base of the IP camera is disposed entirely within the housing, the access panel has at least one hole therethrough, and each said at least one lens of the IP camera extends within a respective said hole in the access panel.

4. The light head as claimed in claim 3, wherein the base is box-shaped and rests against an inner surface of the access panel.

5. The light head as claimed in claim 3, wherein each said at least one lens of the IP camera protrudes from a said hole in the access panel outside the housing.

6. The light head as claimed in claim 3, wherein an outer shape of each said at least one hole in the access panel and an outer contour of a respective said at least one lens of the IP camera are substantially the same.

7. The light head as claimed in claim 6, wherein each said at least one lens of the IP camera protrudes from a said hole in the access panel outside the housing.

8. A streetlight comprising the light head as claimed in claim 1 and a light pole to which the light head is fixed.

9. The streetlight as claimed in claim 9, wherein the access panel and IP camera mounted thereto are disposed closer to the light pole than the light source.

10. A light head, comprising:
a housing;
a light source integral with the housing and positioned to shine a beam of light in a direction away from the housing;
an internet protocol (IP) camera including a base mounted to the housing, and at least one lens supported by the base as exposed to the exterior of the housing; and
a power distribution system including a terminal block disposed in the housing and dedicated for being electrically connected to a main power supply line, the light source and the IP camera being electrically connected to the terminal block independently of each other, and the power distribution system being configured to supply at least some power for powering the light source and the IP camera from the main power supply line through the terminal block.

11. The light head as claimed in claim 10, wherein the housing includes a main body having an opening, and an access panel disposed over the opening and to which the IP camera is fastened, the access panel being mounted to the main body so as to be openable to expose an interior of the housing.

12. A streetlight comprising the light head as claimed in claim 10 and a light pole to which the light head is fixed.

13. The streetlight as claimed in claim 12, and further comprising a photocell disposed outside the housing of the light head, connected to the light source, and operative to control the light source to turn on and off depending upon an amount of ambient light sensed by the photocell, and
wherein the terminal block is configured to electrically connect the IP camera to the main power supply line while bypassing the photocell.

14. The light head as claimed in claim 10, wherein the power distribution system further comprises a battery and smart battery charger connecting the terminal block to the IP camera, whereby the smart battery charger charges the smart battery with power distributed thereto from the terminal block when power is flowing from the main power supply line to the terminal block, and the battery powers the IP camera when no power is supplied to the terminal block via the main power supply line.

15. The light head as claimed in claim 14, wherein the power distribution system further comprises a solar energy battery charger also connected to the battery to charge the battery with solar power.

16. The light head as claimed in claim 10, further comprising a network communication module disposed within the housing, electrically connected to the IP camera and the terminal block of the power distribution system, and operative to wirelessly transmit data produced from images captured by the IP camera.

17. The light head as claimed in claim 16, wherein the network communication module is electrically connected to the IP camera by a Power over Ethernet (POE) cable such that image data output by the IP camera is transmitted along the PoE cable to the module, and at least some power for powering the network communication module is supplied to the module by the power distribution system via the IP camera.

18. A light head comprising:
a housing including a main body having an opening, and an access panel disposed over the opening and mounted to the main body so as to be openable to expose an interior of the housing a lighting system;
a light source integrated with the main body of the housing and operable to shine a beam of light in a direction away from the housing;
an internet protocol (IP) camera having a base fastened to the access panel, and at least one lens supported by the base as exposed to the exterior of the housing;
a power distribution system including a terminal block disposed in the housing and dedicated for being electrically connected to a main power supply line, the light source and the IP camera being electrically connected to the terminal block independently of each other, and the power distribution system being configured to supply at least some power for powering the light source and the IP camera from the main power supply line through the terminal block; and
a network communication module disposed within the housing, electrically connected to the IP camera and the terminal block of the power distribution system, and operative to wirelessly transmit data produced from images captured by the IP camera.

19. The light head as claimed in claim 18, wherein the power distribution system further comprises a photocell connecting the light source to the terminal block and operative to control the light source to turn on and off depending upon an amount of ambient light sensed by the photocell, and wherein the terminal block is configured to electrically connect the IP camera to the main power supply line while bypassing the photocell.

20. The light head as claimed in claim 18, wherein the power distribution system further comprises a battery and smart battery charger connecting the terminal block to the IP camera, whereby the smart battery charger charges the smart battery with power distributed thereto from the terminal block when power is flowing from the main power supply line to the terminal block, and the battery powers the IP camera when no power is supplied to the terminal block via the main power supply line.
